(19) United States
(12) Patent Application Publication
(10) Pub. No.: US 2014/0149495 A1
(43) Pub. Date: May 29, 2014

(54) CLOUD-BASED ROUTE PLANNING SYSTEM AND METHOD THEREOF

(71) Applicants: INVENTEC (PUDONG) TECHNOLOGY CORPORATION, (US); INVENTEC CORPORATION, Taipei (TW)

(72) Inventor: Chaucer CHIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/795,711

(22) Filed: Mar. 12, 2013

(30) Foreign Application Priority Data
Nov. 26, 2012 (CN) 201210489267.2

(51) Int. Cl. H04L 29/06

(52) U.S. Cl. CPC H04L 29/06047
USPC 709/203

(57) ABSTRACT

A cloud-based route planning system and a method thereof are provided. A server provides a route plan message, continuously receives a positioning message of a first client, and displays the route plan message and the positioning message on the first client. After a second client logs in to the server, the server sets a right for the second client according to a user state of the second client and allows the second client to select and download a route plan message. When the user state is browsing, the server displays on the second client both the positioning message of the first client and the route plan message downloaded by the second client, and when the user state is feedback, the second client is allowed to upload a feedback message to modify the route plan message.

### BACKGROUND OF THE INVENTION

1. Field of the Invention

The present invention relates to a route planning system and a method thereof, and more particularly to a cloud-based route planning system and a method thereof, in which a route plan message is stored in a server for a client to browse and modify.

2. Description of Related Art

In recent years, with the widespread and vigorous development of Internet, the number of various Internet related applications has mushroomed, one of which is a network application that provides route planning.

Generally, in a conventional way of generating a route plan, information, such as a route, time, and a budget, is arranged in advance and integrated by a planner. However, probably only the planner is able to understand a route plan generated this way, which is also usually suitable for the planner to use only. Even if another person is able to understand and use the generated route plan, after a period of time, whether the route plan is still feasible cannot be ensured, and therefore a problem of failing to learn in real time whether a route plan is reliable occurs.

In view of this, it has been proposed that a route plan is shared through the Internet, and when an error occurs in the route plan, others are able to report the error to the planner by leaving a message or sending an e-mail. In this way, the route plan is able to be maintained, and troubles caused by outdated information are avoided. Nevertheless, this manner relies on modifications by the planner of the route plan, and the reporting of an error by leaving a message or sending an email is very inconvenient and takes a long time. Therefore, the problem of failing to learn in real time whether a route plan is reliable has not been effectively solved yet.

To sum up, it can be known that in the prior art, the problem of failing to learn in real time whether a route plan is reliable has been present for a long time, so it is actually necessary to propose improved technical means to solve this problem.

### SUMMARY OF THE INVENTION

In view of the problem in the prior art, the present invention discloses a cloud-based route planning system and a method thereof.

The cloud-based route planning system disclosed in the present invention is applied to a server, and the server is allowed to perform transmission with a plurality of clients over a network. The system includes: a storage module, a receiving module, an identification module, a transmission module, and a processing module. The storage module is used for storing a route plan message in advance, and the route plan message includes a map message and a route path. The receiving module is used for receiving a positioning message from a first client and displaying the map message and the route path on the first client. The identification module is used for, when a second client requests to log in, verifying the second client, and when the verification succeeds, allowing the second client to log in to the server and setting a right for the second client according to a user state of the second client. The transmission module is used for, after the second client successfully logs in, allowing the second client to select and download one route plan message for displaying on the second client. The processing module is used for, when the user state is browsing, displaying the positioning message of the first client on the second client, and when the user state is feedback, allowing the second client to upload a feedback message to modify the map message and the route path or either of the map message and the route path.

The cloud-based route planning method disclosed in the present invention is applied to a server, and the server is allowed to perform transmission with a plurality of clients over a network. Steps of the method include: providing the server with a route plan message in advance, the route plan message including a map message and a route path; receiving, by the server, a positioning message from a first client and displaying the map message and the route path on the first client; after a second client logs in to the server, setting, by the server, a right for the second client according to a user state of the second client; allowing, by the server, the second client to select and download one route plan message for displaying; and when the user state is browsing, displaying, by the server, the positioning message of the first client on the second client, and when the user state is feedback, allowing the second client to upload a feedback message to modify the map message and the route path or either of the map message and the route path.

The system and the method disclosed in the present invention are described as above, and a difference between the present invention and the prior art lies in that in the present invention, a server provides a route plan message, receives a positioning message from a first client, and displays the route plan message and the positioning message on the first client; and after a second client logs in to the server, the server sets a right for the second client according to a user state of the second client. When the user state is browsing, the server displays on the second client both the positioning message of the first client and the route plan message downloaded by the second client, and when the user state is feedback, the second client is allowed to upload the feedback message to modify the route plan message.

Through the foregoing technical means, the present invention may achieve the technical efficacy of improving the reliability of a route plan.

### BRIEF DESCRIPTION OF THE DRAWINGS

The invention will become more fully understood from the detailed description given herein below illustration only, and thus is not limitative of the present invention, and wherein:

FIG. 1 is a system block diagram of a cloud-based route planning system of the present invention;

FIG. 2 is a method flow chart of a cloud-based route planning method of the present invention;

FIG. 3 is a schematic diagram of a login page provided by a server of the present invention;

FIG. 4 is a schematic diagram of a displayed page when a user state is browsing in the application of the present invention;

FIG. 5 is a schematic diagram showing that a client simultaneously displays a positioning message and a route plan message when a user state is feedback in the application of the present invention; and

FIG. 6A and FIG. 6B are schematic diagrams of pages displayed by a client when a user state is feedback in the application of the present invention.

### DESCRIPTION OF THE EMBODIMENTS

The present invention will be apparent from the following detailed description, which proceeds with reference to the accompanying drawings, wherein the same references relate to the same elements.

Before a cloud-based route planning system and a method thereof disclosed in the present invention are illustrated, terms defined in the present invention are illustrated first. In the present invention, a route plan message refers to data including a map message and a route path. Taking the route from a “point A” to a “point B” as an example, the route plan message may include all maps and the shortest driving path from the “point A” to the “point B”, so as to instruct a user how to reach the “point B” from the “point A”. Taking a route in an entire area (for example, Taipei City) as an example, the route plan message may include a map of this area and a route path formed according to a suggested scenic spot. In practical implementation, the map message and the route path may be changed by a feedback message, for example, a warning icon is added to the map message, and an alternative path is displayed, and this part is illustrated in detail with reference to the accompanying drawings later.

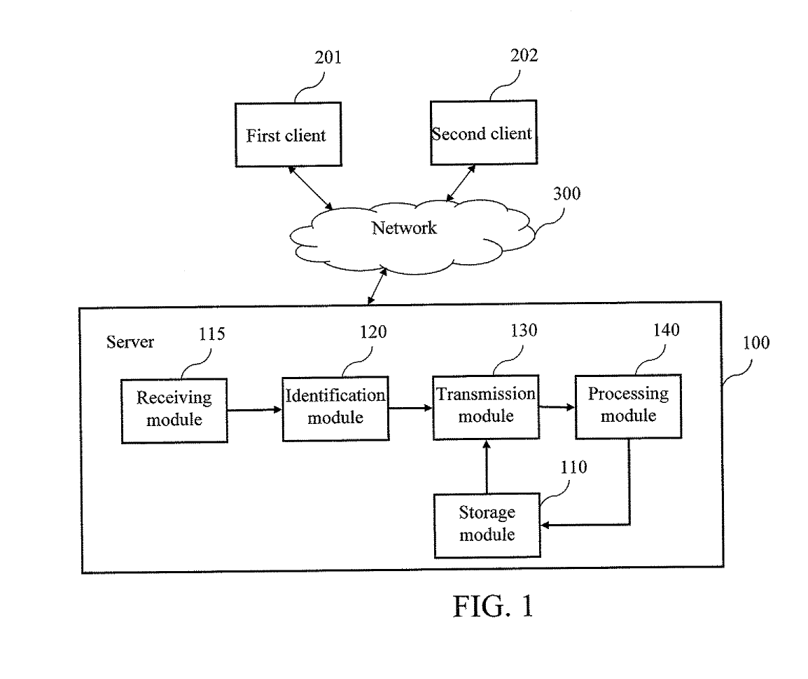

The cloud-based route planning system and the method thereof of the present invention are further illustrated below with reference to the accompanying drawings. Referring to FIG. 1, FIG. 1 is a system block diagram of a cloud-based route planning system of the present invention. The system is applied to a server 100, and the server 100 is allowed to perform transmission with a plurality of clients (for example, a first client 201 and a second client 202) over a network. The system includes: a storage module 110, a receiving module 115, an identification module 120, a transmission module 130, and a processing module 140. The storage module 110 is used for storing a route plan message in advance, and the route plan message includes a map message and a route path. For example, the route plan message includes a driving path from a “point A” to a “point B” on a map. The route plan message is illustrated with reference to the accompanying drawings later. In practical implementation, to reduce the amount of transmitted data of the map message, the map message may be fragmented into a plurality of sub-map messages in advance, and according to a positioning message from the first client 201, an appropriate sub-map message is selected for loading, for example, a sub-map message corresponding to the positioning message and sub-map messages adjacent thereto are loaded. It should be particularly noted that the positioning message may be generated through a global positioning system or by keying in an electrical coordinate. In addition, in practical implementation, the first client 201 and the second client 202 may be personal computers (PCs) or mobile devices, for example, personal digital assistants (PDAs), mobile phones, and tablet PCs. That is to say, any device that is capable of performing data transmission with the server 100 through a network 300 and displaying data does not depart from the application scope of the client.

The receiving module 115 is used for receiving the positioning message from the first client 201 and displaying the map message and the route path on the first client 201. In practical implementation, the first client 201 transmits the positioning message to the server 100 through the network 300 or a satellite positioning system (not shown), and since a transmission manner thereof is a conventional technology, the transmission manner thereof is not described herein again.

The identification module 120 is used for, when the second client 202 requests to log in to the server 100, verifying the second client 202, and a verification manner thereof may be implemented through an account and a password. It should be particularly noted that when the verification of the second client 202 succeeds, apart from allowing the second client 202 to log in, the server 100 also sets a right for the second client 202 according to a user state of the second client. The user state may include two states, that is, browsing and feedback, and the user state may be preset before the second client 202 logs in or may be set after the second client 202 logs in. When the user state is set as browsing, it is represented that the server 100 grants a right of displaying the positioning message of the first client 201 on the second client 202, and when the user state is set as feedback, it is represented that the server 100 grants the right that the second client 202 uploads a feedback message to modify the map message and the route path in the route plan message or either of the map message and the route path, and the server 100 may even likewise grant the right of displaying on the second client 202 the positioning message of the first client 201.

The transmission module 130 is used for, when the second client 202 successfully logs in, allowing the second client 202 to select and download one route plan message. For example, it is assumed that a plurality of route plan messages are present, such as a “route plan from the point A to the point B” and a “route plan from the point B to a point C”, a user at the second client 202 may select one route plan message thereof for downloading. Since the selection and downloading of the route plan message is a conventional technology, the selection and downloading of the route plan message is not described herein again.

The processing module 140 is used for, when the user state is browsing, displaying the positioning message of the first client 201 on the second client 202. For example, it is assumed that the first client 201 and the second client 202 select the same route plan message for downloading, the first client 201 sends the positioning message to the server 100, and when the second client 202 successfully logs in to the server 100 and the user state is browsing, the server 100 also displays the positioning message on the second client 202. In this way, the second client 202 may learn the position of the first client 201. In addition, when the user state set by the second client 202 is feedback, the second client 202 is allowed to upload a feedback message to modify the map message and the route path in the route plan message or either of the map message and the route path. For example, the user at the second client 202 may input an image, a video, and a text or at least one thereof, as a feedback message, into the map message, and transmit the feedback message to the server 100, so as to modify a corresponding route plan message in the storage module 110. Therefore, a map message and a route path in the route plan message or either of the map message and the route path can be maintained at the latest condition, thereby avoiding a situation that data in the route plan message cannot be used because the data is outdated, which influences the reliability of a route plan.

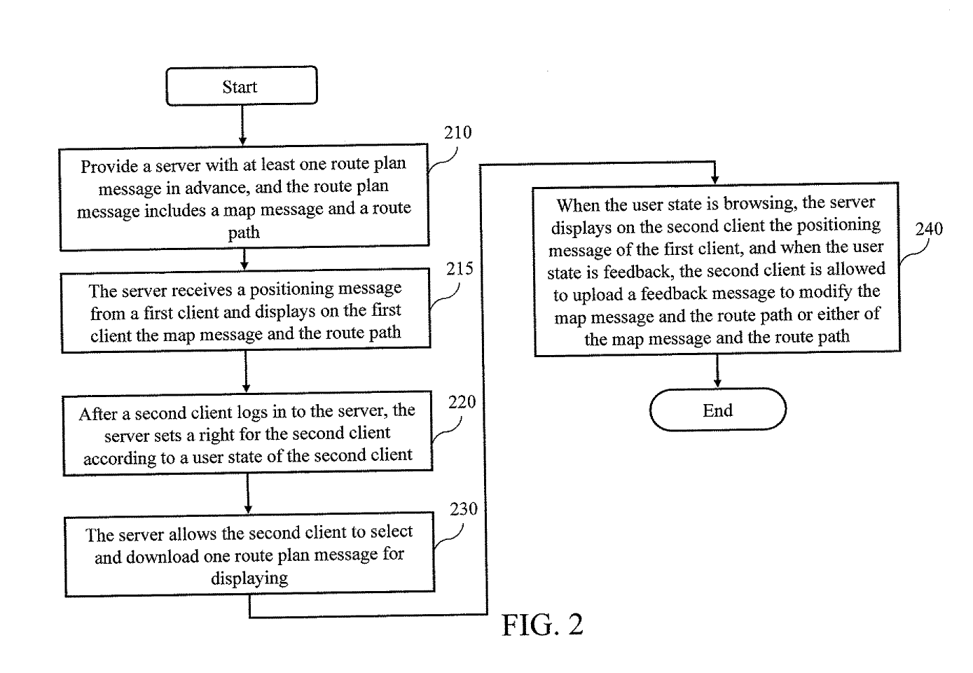

Subsequently, referring to FIG. 2, FIG. 2 is a method flow chart of a cloud-based route planning method of the present invention. The method is applied to a server 100, and the server 100 is allowed to perform transmission with a plurality of clients (for example, a first client 201 and a second client 202) over a network. Steps of the method include: providing a server 100 with a route plan message in advance, the route plan message including a map message and a route path (Step 210); receiving, by the server 100, a positioning message from the first client 201 and displaying the map message and the route path on the first client 201 (Step 215); after the second client 202 logs in to the server 100, setting, by the server 100, a right for the second client 202 according to a user state of the second client 202 (Step 220); allowing, by the server 100, the second client 202 to select and download one route plan message for displaying (Step 230); and when the user state is browsing, displaying, by the server 100, on the second client 202 the positioning message of the first client 201, and when the user state is feedback, allowing the second client 202 to upload a feedback message to modify the map message and the route path or either of the map message and the route path (Step 240). Through the above steps, the server 100 may provide the route plan message, receive the positioning message of the first client 201, and display the route plan message and the positioning message on the first client 201. After the second client 202 logs in to the server 100, the server 100 sets the right for the second client 202 according to the user state and allows the second client 202 to select and download the route plan message. When the user state is browsing, the server 100 displays on the second client 202 both the positioning message of the first client 201 and the route plan message downloaded by the second client 202, and when the user state is feedback, the second client 202 is allowed to upload a feedback message to modify the route plan message.

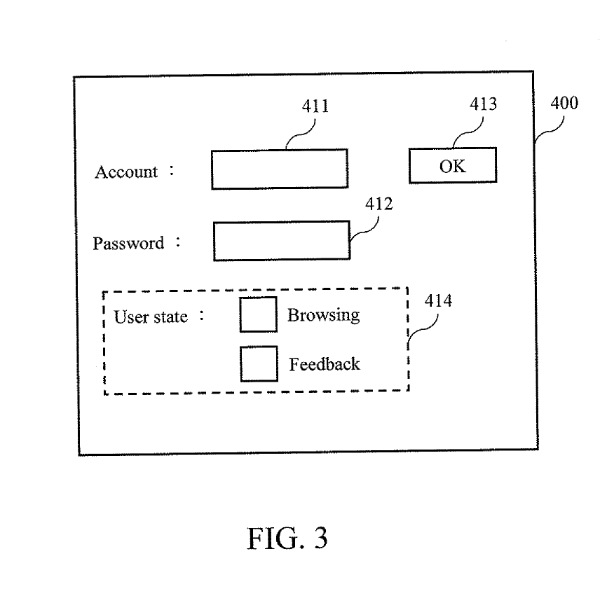

Illustration is made below in a manner of an embodiment with reference to FIG. 3 to FIG. 6. First, referring to FIG. 3, FIG. 3 is a schematic diagram of a login page provided by the server of the present invention. When a user at a first client 201 intends to travel but does not know how to plan a route, the user may be connected, through the first client 201, to a login page 400 provided by a server 100 to log in. After the user keys an account and a password into an account input block 411 and a password input block 412, the user clicks an OK button 413 and then may log in and browse a route plan provided by the server 100 in advance. The server 100 continuously receives a positioning message from the first client 201, and, together with a route plan selected by the user, displays the positioning message and a map message and a route path on the first client 201. A user of the second client 202 likewise logs in through the login page 400, but may set a user state as, for example, browsing or feedback through a user state input block 414. It should be particularly noted that the present invention illustrates the login page of the server 100 with the foregoing example, but the present invention is not limited thereto. That is to say, in practical implementation, the user may log in by only inputting an account and a password, and the user state input block 414 may be provided for the user to perform setting after the user logs in to the server 100.

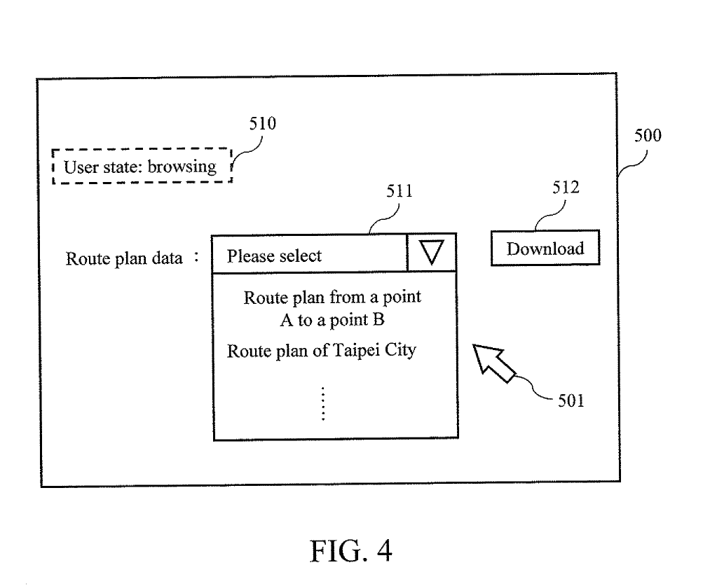

Subsequently, as shown in FIG. 4, FIG. 4 is a schematic diagram of a displayed page when the user state is browsing in the application of the present invention. After the verification of the second client 202 succeeds and the second client 202 logs in to the server 100, the server 100 sets a right for the second client 202 according to the user state set by the user. When it is assumed that the user state is browsing, a browsing page 500 shown in FIG. 4 is displayed. The user may learn a current user state through a user state display block 510, and after the user clicks a route plan selection component 511 through a cursor 501 and selects route plan data stored in the storage module 110 in advance, the user clicks a download component 512 to download the selected route plan data.

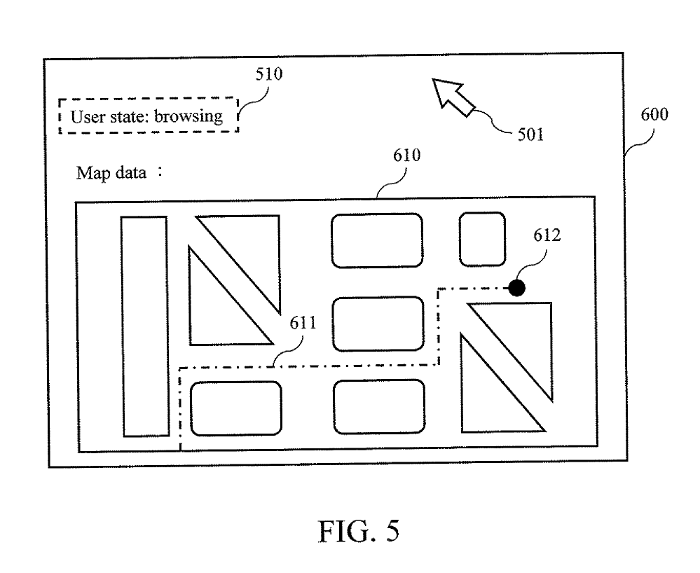

Referring to FIG. 5, FIG. 5 is a schematic diagram showing that a client simultaneously displays a positioning message and a route plan message when the user state is browsing in the application of the present invention. When the route plan data selected and downloaded by the second client 202 is the same as that of the first client 201, the positioning message of the first client 201 and the route plan message are simultaneously displayed on the second client 202 through a page 600 shown in FIG. 5. The positioning message is presented as a positioning point 612, the map message of the route plan message is displayed through a map display block 610, and a route path is presented through a path segment 611. In this way, the user at the second client 202 may observe whether the user of the first client 201 moves according to guidance of the path segment 611.

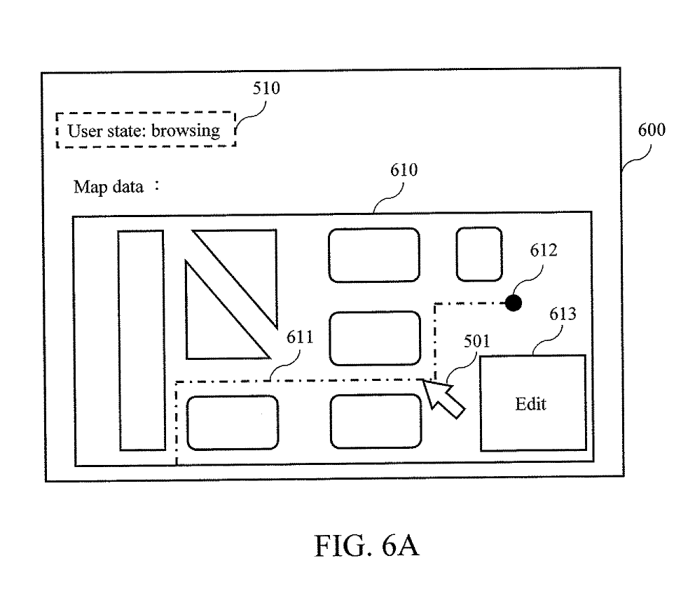

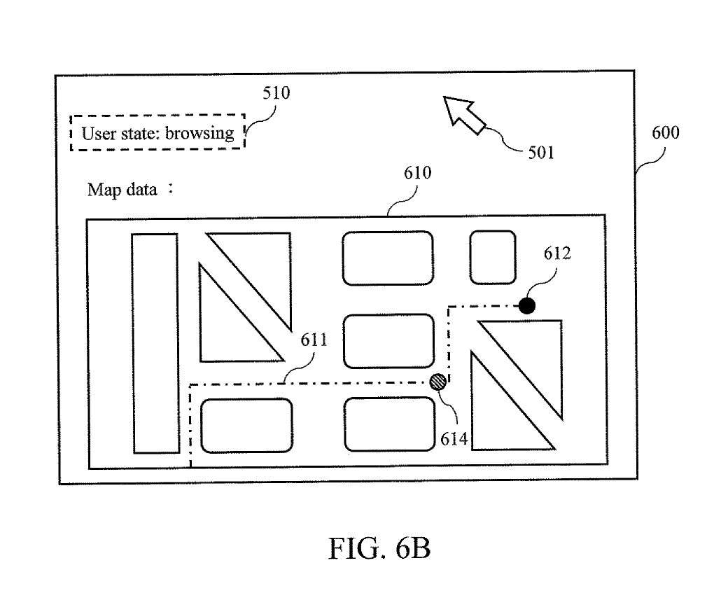

Subsequently, referring to FIG. 6A and FIG. 6B, FIG. 6A and FIG. 6B are schematic diagrams of pages displayed on a client when the user state is feedback in the application of the present invention. When the user state is feedback, the second client 202 may display the map message in the map display block 610 in the page 600 and present the route path through the path segment 611 as when the user state is browsing, and may even receive the positioning message of the first client 201 and present the positioning message through a positioning point 612 shown in FIG. 6A. However, a difference between situations when the user state is browsing and when the user state is feedback lies in that when the user state is feedback, the user of the second client 202 may select map information in the map display block 610 through the cursor 501, and at this time, an edit block 613 is generated for the user to input an image, a video, and a text or at least one thereof as a feedback message. For example, the user may input characters like “road construction” and input an image or a video through a photographic device. The generated edit block 613 may be implemented through a web script language, for example, a “Java Script”. It should be particularly noted that, apart from inputting an image, a video, and a text, the user may also modify the path segment 611 as an alternative path and use the alternative path (not shown) as the feedback message.

Subsequently, after the user finishes inputting the feedback message, the second client 202 uploads the feedback message to the server 100 to modify a map message of a corresponding route plan message (that is, to add the feedback message to the map message). After that, when a user of another client downloads the same route plan message, as shown in FIG. 6B, a feedback icon 614 may be used to present the added feedback message, and after the cursor 501 is used to click the feedback icon 614, the image, the video, and the text or at least one thereof is displayed. It should be particularly noted that the present invention illustrates a manner of displaying the route plan message through the foregoing example, but the present invention is not limited thereto, and any presentation manner that is capable of providing a route plan comprehensible to the user does not depart form an application scope of the present invention.

To sum up, it can be known that a difference between the present invention and the prior art lies in that the server provides the route plan message, continuously receives the positioning message of the first client, and displays the route plan message and the positioning message on the first client, and after the second client logs in to the server, the server sets the right for the second client according to the user state and allows the second client to select and download the route plan message. When the user state is browsing, the server displays both the positioning message of the first client and the route plan message downloaded by the second client on the second client, and when the user state is feedback, the second client is allowed to upload the feedback message to modify the route plan message, so as to achieve the technical efficacy of improving the reliability of a route plan.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A cloud-based route planning system, applied to a server, the server being allowed to perform transmission with a plurality of clients over a network, the system comprising:
a storage module, used for storing at least one route plan message in advance, wherein the route plan message comprises a map message and a route path;
a receiving module, used for receiving a positioning message from a first client and displaying the map message and the route path on the first client;
an identification module, used for, when a second client requests to log in, verifying the second client, and after the verification succeeds, allowing the second client to log in to the server and setting a right for the second client according to a user state of the second client;
a transmission module, used for, after the second client successfully logs in, allowing the second client to select and download one route plan message for displaying on the second client; and
a processing module, used for, when the user state is browsing, displaying on the second client the positioning message of the first client, and when the user state is feedback, allowing the second client to upload a feedback message to modify the map message and the route path or either of the map message and the route path.

2. The cloud-based route planning system according to claim 1, wherein the map message and the feedback message comprise an image, a video and a text or at least one thereof.

3. The cloud-based route planning system according to claim 1, wherein the user state is preset as browsing or feedback when the second client logs in to the server.

4. The cloud-based route planning system according to claim 1, wherein the positioning message is generated through a global positioning system or by keying in an electrical coordinate.

5. The cloud-based route planning system according to claim 1, wherein the map message comprises a plurality of sub-map messages, and when the route plan message is displayed, a part of the sub-map messages are selected and loaded according to the position of the positioning message.

6. A cloud-based route planning method, applied to a server, the server being allowed to perform transmission with a plurality of clients over a network, the method comprising the steps of:
providing the server with at least one route plan message in advance, wherein the route plan message comprises a map message and a route path;
receiving, by the server, a positioning message from a first client and displaying the map message and the route path on the first client;
after a second client logs in to the server, setting, by the server, a right for the second client according to a user state of the second client;
allowing, by the server, the second client to select and download one route plan message for displaying; and
when the user state is browsing, displaying, by the server, on the second client the positioning message of the first client, and when the user state is feedback, allowing the second client to upload a feedback message to modify the map message and the route path or either of the map message and the route path.

7. The cloud-based route planning method according to claim 6, wherein the map message and the feedback message comprise an image, a video, and a text or at least one thereof.

8. The cloud-based route planning method according to claim 6, wherein the user state is preset as browsing or feedback when the second client logs in to the server.

9. The cloud-based route planning method according to claim 6, wherein the positioning message is generated through a global positioning system or by keying in an electrical coordinate.

10. The cloud-based route planning method according to claim 6, wherein the map message comprises a plurality of sub-map messages, and when the route plan message is displayed, a part of the sub-map messages are selected and loaded according to the position of the positioning message.
